(19) United States
(12) Patent Application Publication
(10) Pub. No.: US 2017/0339430 A1
(43) Pub. Date: Nov. 23, 2017

(54) ENCODER, DECODER, METHOD OF ENCODING DATA, METHOD OF DECODING DATA, UTILIZING DATA FORMAT TRANSFORMATIONS

(71) Applicant: GURULOGIC MICROSYSTEMS OY, Turku (FI)

(72) Inventor: Ossi KALEVO, Akaa (FI)

(21) Appl. No.: 15/533,371

(22) PCT Filed: Dec. 9, 2015
(86) PCT No.: PCT/EP2015/025101

§ 371 Date: Jun. 5, 2017

(30) Foreign Application Priority Data
Dec. 9, 2014 (GB) 1421875.4

(51) Int. Cl. H04N 19/61; H04N 19/186; H04N 19/50; H04N 19/85

(52) U.S. Cl. CPC H04N 19/61; H04N 19/85; H04N 19/186; H04N 19/50

(57) ABSTRACT

An encoder including processing hardware for encoding input data (D1), for example image and/or video data (D1), to generate corresponding encoded data (E2), wherein the input data (D1) is provided in a first data format, for example a first color space. The processing hardware of the encoder is operable to transform the input data (D1) from the first data format into at least one second data format, for example a second color space, and to encode the transformed data from the at least one second data format to generate the encoded data (E2), wherein the encoded data (E2) also includes information that is indicative of one or more transformations and/or data formats employed to transform the input data (D1) from the first data format into the at least one second data format.

### TECHNICAL FIELD

The present disclosure relates to encoders for encoding data for example to encoders for encoding image and/or video data in a lossless manner using mutually different color (UK English “colour”) spaces. Moreover, the present disclosure concerns methods of encoding data, for example methods of encoding image and/or video data, for example in a lossless manner using mutually different color spaces. Furthermore, the present disclosure relates to decoders for decoding encoded data generated by the aforementioned encoders. Additionally, the present disclosure concerns methods of decoding encoded data, wherein the encoded data is generated by the aforementioned encoders and the aforementioned methods. Yet additionally, the present disclosure is concerned with computer program products comprising a non-transitory computer-readable data storage medium having computer-readable instructions stored thereon, the computer-readable instructions being executable by a computerized device comprising processing hardware to execute the aforesaid methods. Yet additionally, the present disclosure concerns codecs including at least one aforementioned encoder and at least one aforementioned decoder.

### BACKGROUND

Conventionally, a typical video and/or image codec is operable to compress data only in one color space, or with a few pixel formats, and typically the support for different input formats for the codec is also very limited. For example, according to a contemporary JPEG/H.264/HEVC standard, associated methods compress images only in a YCbCr color space. According to a contemporary PNG standard, associated methods compress images only in a sRGB color space.

PNG and JPEG support “.bmp” format images, but a typical JPEG implementation often is not able to provide lossless encoding of such images. A lossless JPEG implementation, as aforementioned, is able to code other sRGB images losslessly, yet yields a very poor compression ratio. However, greyscale images can sometimes be coded losslessly even with a regular lossy JPEG implementation, because it is sometimes in theory possible to code the luminance channel (Y) completely losslessly with a regular lossy JPEG implementation. Moreover, a greyscale image can be generated from RGB channels into a Y channel, that then additionally has a U channel, namely blue chrominance, and a V channel, namely red chrominance, which are set to a constant value. Moreover, contemporary H.264 and HEVC (see reference [1]) implementations support only “.yuv” format images. However, the HEVC implementation has a more recent mode of operation that enables lossless coding of YCbCr color space image, but the H.264 implementation can only perform lossy encoding.

If a color conversion were executed on original information, for example by employing a conversion pair described in reference [1] below, both before compression being applied and after the compression being applied, then the original information is typically not recovered losslessly. Such a loss arises from a distortion caused by the color conversion from an original color space of the original information and the color conversion back to the original color space.

Currently, only data zippers, such as contemporary 7zip, rar and pkzip (wherein these names include registered trademarks) and lossless JPEG, are able to encode and decode images and videos losslessly in any given color space or in any image/video format. A problem that is contemporarily encountered is that zippers do not understand data content that is required to be processed, and therefore, a compression efficiency of a zipper-based codec is poor. Moreover, the content cannot be modified easily. A zipper returns the original content exactly as it was. Moreover, neither a zipper nor a lossless JPEG implementation are able to reduce correlation between color channels as efficiently as real image and/or video codecs, during compression.

There is presently a lack of, namely one single, efficient approach to encode images and videos in a lossless manner in different color spaces. Such a lack represents a problem, which the present disclosure seeks to address.

Various known methods of encoding and decoding data are described in earlier patent documents US2014/355689A1 (Tourapis et al.), WO2004/100504A2 (Ventana et al.), WO2013/146405A1 (KDDI), and also U.S. Pat. No. 6,094,454A (Mitchell et al.).

### SUMMARY

The present disclosure seeks to provide an encoder which is operable to compress input data in a more efficient manner, for example an encoder which is operable to compress image and/or video data in a more efficient manner.

Moreover, the present disclosure seeks to provide a method of compressing input data in a more efficient manner, for example a method of compressing image and/or video data in a more efficient manner.

Furthermore, the present disclosure seeks to provide a decoder for decoding compressed encoded data as generated by the aforementioned encoder.

Additionally, the present disclosure seeks to provide a method of decompressing compressed encoded data in a more efficient manner.

A further aim of the present disclosure is to at least partially overcome at least some of the problems of the prior art, as described above.

In a first aspect, there is provided an encoder including processing hardware for encoding input data (D1) to generate corresponding encoded data (E2), wherein the input data (D1) is provided in a first data format, characterized in that the processing hardware of the encoder is operable to transform the input data (D1) from the first data format into at least one second data format, and to encode the input data in a lossless manner utilizing the at least one second data format to generate the encoded data (E2), wherein the encoded data (E2) includes information that is indicative of a one or more transformations and/or data formats employed to transform the input data (D1) from the first data format into the at least one second data format.

The present invention is of advantage in that the encoder is capable of compressing input data, for example image and/or video data, in a more efficient manner by transforming the input data from the first data format to the at least a second data format, from which compression is capable of being more efficiently done.

Optionally, the aforementioned “data format” is to be regarded as being a “format space”.

Optionally, the encoder is operable to generate the encoded data (E2) including information indicative of the one or more transformations and/or the data formats employed to transform the input data (D1) from the first data format into the at least one second data format, wherein the information contains at least one of:
(a) information indicative of a conversion employed in the encoder, for example in a form “first data format to second data format”;
(b) information indicative of an inverse conversion needed in a decoder, for example in a form “from a second data format to a first data format”;
(c) information indicative of coefficients used in the one or more transformations and either the first or the second data format; and
(d) information indicative of the first data format and the second data format.

Optionally, the encoder is operable to represent the one or more transformations by one or more corresponding reference codes in header information included in the encoded data (E2)

Optionally, the encoder is operable to combine different distortions arising from employing lossy transformations and/or lossy coding, when transforming the input data from the at least one second format to generate the encoded data (E2), and to include information indicative of the combined different distortions in the encoded data (E2) so that lossless encoding is thereby provided.

Optionally, the first and second data formats include first and second color spaces, respectively. Optionally, the input data (D1) includes at least one of: image data, video data, audio data, seismic data, medical imaging data, but not limited thereto.

Moreover, optionally, the selection of the one or more data formats varies depending on subsampling, dynamics and so forth.

In a second aspect, there is provided a decoder including processing hardware for decoding encoded data (E2) to generate corresponding decoded data (D3); the processing hardware of the decoder is operable to decode the encoded data (E2) to generate intermediate data in at least a second data format; the processing hardware of the decoder is operable to determine from the encoded data (E2) one or more transformations required for transforming the intermediate data from the at least a second data format into a first data format to generate the decoded data (D3).

Optionally, the processing hardware of the decoder is operable to determine from the encoded data (E2) information indicative of the one or more transformations and/or the data formats employed to transform the input data (D1) from the first data format into the at least one second data format, wherein the information contains at least one of:
(a) information indicative of a conversion employed in an encoder, for example in a form “first data format to second data format”;
(b) information indicative of an inverse conversion needed in the decoder, for example in a form “from second data format to first data format”;
(c) information indicative of coefficients used in the one or more transformations and either the first or the second data format; and
(d) information indicative of the first data format and the second data format.

Optionally, the aforementioned “data format” is regarded as being a “format space”.

Optionally, the first and second data formats include first and second color spaces, respectively.

In a third aspect, there is provided a codec including at least one aforementioned encoder and at least one aforementioned decoder.

In a fourth aspect, there is provided a method of encoding input data (D1) to generate corresponding encoded data (E2), via an encoder including processing hardware, wherein the input data (D1) is provided in a first data format, characterized in that the method includes:
(i) transforming the input data (D1) from the first data format into at least one second data format; and
(ii) encoding the input data (D1) in a lossless manner utilizing the at least one second data format to generate the encoded data (E2),

wherein the encoded data (E2) also includes information that is indicative of one or more transformations and/or data formats employed to transform the input data (D1) from the first data format into the at least one second data format.

Optionally, the input data (D1) includes image and/or video data, but is not limited thereto.

Optionally, the aforementioned “data format” is to be regarded as being a “format space”.

Optionally, the first and second data formats include first and second color spaces, respectively.

In a fifth aspect, there is provided a computer program product comprising a non-transitory computer-readable data storage medium having computer-readable instructions stored thereon, the computer-readable instructions being executable by a computerized device comprising processing hardware to execute the aforementioned method of encoding.

In a sixth aspect, there is provided a method of decoding encoded data (E2) to generate corresponding decoded data (D3), via a decoder including processing hardware, characterized in that the method includes:
(i) decoding the encoded data (E2) to generate intermediate data in at least one second data format; and
(ii) determining from the encoded data (E2) one or more transformations and/or data formats required for transforming the intermediate data from the at least one second data format into a first data format to generate the decoded data (D3).

Optionally, the aforementioned “data format” is to be regarded as being a “format space”.

Optionally, the first and second data formats include first and second color spaces, respectively.

In a seventh aspect, there is provided a computer program product comprising a non-transitory computer-readable data storage medium having computer-readable instructions stored thereon, the computer-readable instructions being executable by a computerized device comprising processing hardware to execute the aforementioned method of decoding.

Embodiments of the present disclosure are capable of providing an at least partial solution to the aforementioned problem, and are capable of executing an efficient and lossless image/video compression.

Additional aspects, advantages, features and objects of the present disclosure would be made apparent from the drawings and the detailed description of the illustrative embodiments construed in conjunction with the appended claims that follow.

It will be appreciated that features of the present disclosure are susceptible to being combined in various combinations without departing from the scope of the present disclosure as defined by the appended claims.

### BRIEF DESCRIPTION OF THE DRAWINGS

The summary above, as well as the following detailed description of illustrative embodiments, is better understood when read in conjunction with the appended drawings. For the purpose of illustrating the present disclosure, exemplary constructions of the disclosure are shown in the drawings. However, the present disclosure is not limited to specific methods and apparatus disclosed herein. Moreover, those in the art will understand that the drawings are not to scale. Wherever possible, like elements have been indicated by identical numbers.

Embodiments of the present disclosure will now be described, by way of example only, with reference to the following diagrams wherein:

FIG. 1 is a schematic illustration of a block diagram of a codec, pursuant to embodiment of the present disclosure;

FIG. 2 is a schematic illustration of an encoder for encoding image and/or video data (D1) to generate corresponding encoded data (E2) and a decoder for decoding the encoded data (E2) to generate corresponding decoded data (D3), wherein the encoder and the decoder collectively form a codec, in accordance with an embodiment of the present disclosure;

FIG. 3 is a schematic illustration of a flow chart depicting steps of a method of encoding image and/or video data (D1) to generate corresponding encoded data (E2), in accordance with an embodiment of the present disclosure; and

FIG. 4 is a schematic illustration of a flow chart depicting steps of a method of decoding encoded data (E2) to generate corresponding decoded data (D3), in accordance with an embodiment of the present disclosure.

In the accompanying diagrams, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DETAILED DESCRIPTION OF EMBODIMENTS

The following detailed description illustrates embodiments of the present disclosure and ways in which they can be implemented. Although some modes of carrying out the present disclosure has been disclosed, those skilled in the art would recognize that other embodiments for carrying out or practicing the present disclosure are also possible.

In a first aspect, embodiments of the present disclosure provide an encoder including processing hardware for encoding input data (D1) to generate corresponding encoded data (E2). Optionally, the processing hardware of the encoder is implemented by employing at least one Reduced Instruction Set Computing (RISC) processor that is operable to execute program instructions as will be elucidated in detail below. Optionally, the input data (D1) includes at least one of: image data, video data, audio data, seismic data, medical imaging data, but not limited thereto.

The input data (D1), for example image and/or video data, is provided in a first data format, for example a first color space. The processing hardware of the encoder is operable to transform the input data (D1) from the first data format into at least a second data format, for example a second color space. The processing hardware of the encoder is then operable to encode the transformed data from the at least a second data format to generate the encoded data (E2). The encoded data (E2) includes information that is indicative of one or more transformations employed to transform the input data (D1) from the first data format into the at least a second data format. Optionally, the aforementioned “data format” is regarded as being a “format space”.

According to various embodiments of the present disclosure, the aforesaid encoder is optionally used to encode images and/or videos in various different color spaces and/or different pixel formats, as a part of a single integrated codec solution. Pursuant to embodiments of the present disclosure, the encoder enables efficient and lossless, or substantially lossless, image and video compression, for example, for medical or military purposes.

It is to be noted here that the aforesaid encoder is optionally implemented with an electronic device or as a part of an electronic device. In an example, the electronic device is optionally an image and/or video capturing device that generates large quantities of image and/or video data, wherein lossless compression is desired so as to preserve fine information in the image and/or video data, whilst rendering the quantities of the image and/or video data manageable for data storage and data communication purposes. Examples of such image and/or video capturing devices include, but are not limited to, surveillance cameras, video recorders, X-ray devices, Magnetic Resonance Imaging (MRI) scanners, and ultrasound scanners.

In an embodiment, the processing hardware of the encoder is operable to execute a lossless image and/or video compression.

In another embodiment, the processing hardware of the encoder is operable to execute a lossy, yet efficient, image and/or video compression. Additionally, in this regard, the processing hardware of the encoder is operable to generate residual information that is indicative of one or more errors, namely distortions, arising when transforming the image and/or video data (D1) from the first data format into the at least a second data format. Optionally, the processing hardware of the encoder is operable to encode the residual information into the encoded data (E2) for enabling the encoded data (E2) to be subsequently losslessly decoded.

It will be appreciated that distortions can arise as a result of employing a lossy transformation, but can also be a result of employing lossy coding. It is advantageous to combine different distortions and to code the corresponding residual information simultaneously.

Optionally, the processing hardware of the encoder is operable to analyze the image and/or video data (D1), and to select the one or more transformation depending upon content of the image and/or video data (D1). Based on the content, it is feasible to select at least one transformation that is lossless, for example by way of employing a greyscale image, or part thereof, which is susceptible to being converted between different color formats in a lossless manner. In other words, the content is also optionally information of only part of a given image and is susceptible to being converted to such a format that is possible to retain losslessly later on. In such a case, information of the part of the given image beneficially does not exceed the amount of data that is possible to be described in a lossless manner with a given format, and such an issue is beneficially checked from content present in the given image and/or video data present in the input data (D1). The selection of the one or more transformations is beneficially achieved by way of at least one of: Fourier analysis, entropy analysis, rule-based analysis or similar performed on at least a portion of the input data (D1), neural network analysis of image and/or video components.

Optionally, encoding the transformed data from the at least a second data format is more efficient than encoding the image and/or video data (D1) from the first data format directly. The efficiency relates mostly to the compression ratio but in some cases it is beneficial to optimize speed of computation and memory consumption of the method. Optionally, in this regard, the processing hardware of the encoder is operable to select the at least a second data format, such that the encoding of the transformed data from the at least a second data format is more efficient than the encoding the image and/or video data (D1) from the first data format directly.

According to an embodiment, the processing hardware of the encoder is operable to transform the image and/or video data (D1) from the first color space into a plurality of color spaces. Optionally, each color space of the plurality of color spaces is selected, such that it is more efficient to encode the transformed data from that color space than to encode the image and/or video data (D1) from the first color space directly; as aforementioned, the selection of the plurality of color spaces is beneficially achieved by way of at least one of: Fourier analysis, entropy analysis, rule-based analysis or similar performed on at least a portion of the input data (D1), neural network analysis of image and/or video components.

More optionally, at least one color space of the plurality of color spaces is most efficient, when compared to the first color space and/or other color spaces of the plurality of color spaces.

Throughout the present disclosure, the term “color space” generally refers to a specific organization of colors, which makes it possible to reproducibly represent colors in both analogue and digital representations. A color space may either be structured mathematically, for example, such as with Adobe RGB or sRGB, or be arbitrary with particular colors assigned to a set of physical color swatches and/or corresponding assigned names or numbers, for example, such as with the Pantone Matching System (PMS). Examples of color spaces include, but are not limited to, RGB, sRGB, Adobe RGB, Adobe Wide Gamut RGB, ProPhoto RGB, scRGB, Rec. 709, Rec. 2020, CIE RGB, CIE XYZ, CIELUV, CIEUVW, CIELAB, YUV, YIQ, YDbDr, YPbPr, YCbCr, xvYCC, CMYK, HSV, HSL, Munsell color system, Pantone Matching System (PMS), and Natural Color System (NCS); these examples include registered trademarks. RGB and CMYK are color models that are typically used as a basis for different color spaces.

Moreover, optionally, the image and/or video data (D1) is provided in a first pixel format associated with the first color space, while the transformed data is provided in at least a second pixel format associated with the at least a second color space. Optionally, in this regard, the processing hardware of the encoder is operable to transform the image and/or video data (D1) from the first pixel format into the at least a second pixel format during the transformation. Examples of the first pixel format and/or the at least a second pixel format include, but are not limited to, RGB/BGR 8, RGB/BGR 16, RGB/BGR 24, RGB/BGR 32, RGBA32, 1444, 1422, 1420, J422, J420, YV16, and YV12, Y8, Y8 and a palette for 24 bit RGB; these examples include registered trademarks.

Optionally, the image and/or video data (D1) is received as a stream or a file. The file is optionally provided in any suitable file format. Examples of such file formats include, but are not limited to, the Portable PixMap format (PPM), the Portable GrayMap format (PGM), the Portable BitMap format (PBM), the BitMaP file format (BMP), the YUV4MPEG2 format, the YUV format, the Portable Network Graphics format (PNG), the Joint Photographic Experts Group format (JPEG), and the Graphics Interchange Format (GIF). Examples of corresponding filename extensions include, but are not limited to, “.ppm”, “.pgm”, “.pbm”, “.bmp”, “.y4m”, “.yuv”, “.png”, “.jpeg”, and “.gif”. These filename extensions refer to qualifying endings of data files as recorded in a contemporary file directory.

Moreover, optionally, the processing hardware of the encoder is operable to remove unnecessary information, for example redundant information, from a given header of the image and/or video data (D1).

Additionally or alternatively, optionally, the processing hardware of the encoder is operable to remove unnecessary information from one or more channels of the image and/or video data (D1) that are less relevant (hereinafter referred to as “less-relevant channels”). Such removal of unnecessary information is optionally performed without degrading or distorting original image and/or video information in one or more other channels of the image and/or video data (D1) that are more relevant (hereinafter referred to as “more-relevant channels”). This potentially enables an efficient channel correlation between the first color space and the at least a second color space. This also enables flexibility in respect of pixel formats that can be employed.

In this regard, optionally, the processing hardware of the encoder is operable to encode the more-relevant channels first, and then to encode the less-relevant channels. This potentially enables a more efficient channel correlation reduction.

Throughout the present disclosure, the term “channel” generally refers to a certain component of an image. In some examples, the term “channel” refers to a color channel that corresponds to a range of wavelengths. As an example, in the RGB and CMYK color models, a color channel typically includes spectroscopic information that is indicative of radiation intensity corresponding to a given primary color, namely red, green or blue in the RGB color model, or cyan, magenta, yellow and black in the CMYK color model. In the YUV color space, a Y channel corresponds to luminance, while U and V channels correspond to chrominance. In the HSV color space, one channel corresponds to brightness, while other two channels correspond to color information.

In other examples, the term “channel” refers to other channels, for example, such as metadata, text, binary data, audio channels, preview image channels, transparent image channels, an alpha channel, and channels of other views of a three-dimensional image, but are not limited thereto.

It is to be noted here that a given color space has a plurality of channels, wherein often at least one channel of the plurality of channels is more relevant than one or more other channels of the plurality of channels. As an example, in the YUV or YCbCr color spaces, the Y channel includes most information, and therefore, is more relevant than other channels. Thus, it is advantageous to encode the Y channel first, so as to enable the more efficient channel correlation reduction. Similarly, in the sRGB color space, a G channel includes most information, and therefore, is more relevant than R and B channels. Optionally, the channels are encoded and subsequently decoded separately.

Optionally, the channels utilize information from each other. This potentially enables flexibility in respect of usage.

Moreover, optionally, the processing hardware of the encoder is operable to add information into a new header and/or one or more new channels of the transformed data. Such addition of information is optionally performed without degrading or distorting the original image and/or video information in the relevant channels. It is to be noted here that such new headers and/or new channels are typically formed as a result of the transformation.

Pursuant to embodiments of the present disclosure, original image and/or video header is typically not delivered in any format from the encoder to a corresponding decoder, if there is no request to return an output file that is exactly similar to an original file. Typically, image and/or video content of the image and/or video data (D1) is preserved losslessly, and then a new header that is similar to the original image and/or video header as employed in the original file is generated in the decoder.

If the original image and/or video header includes metadata or other critical data, it is delivered as its own channel or as header information in a new pixel format, depending on the image and/or video content and an amount of the image and/or video data (D1). A given media player associated with the decoder is then able to select how to use or show information available in such channels or headers to a user. In an example, additional text or graphics is separately shown on top of the image and/or video. In another example, the additional text or graphics is overlaid to the image and/or video with or without transparency. In yet another example, only a preview image is decoded and then shown. In still another example, only metadata is shown.

Furthermore, optionally, the encoder is operable to communicate the encoded data (E2) to a data server and/or data storage for storing in a database. The data server and/or data storage is arranged to be accessible to a decoder, which is beneficially compatible with the encoder, for subsequently decoding the encoded data (E2).

In some examples, the decoder is optionally operable to access the encoded data (E2) from the data server and/or data storage.

In alternative examples, the encoder is optionally operable to stream the encoded data (E2) to the decoder, either via a communication network or via a direct connection. Moreover, it is to be noted that a device equipped with a hardware-based or software-based encoder optionally also communicates directly with another device equipped with a hardware-based or software-based decoder.

In yet other alternative examples, the decoder is optionally implemented so as to retrieve the encoded data (E2) from a non-transitory (namely non-transient) computer-readable storage medium, such as a hard drive and a Solid-State Drive (SSD).

In a second aspect, embodiments of the present disclosure provide a decoder including processing hardware for decoding encoded data (E2) to generate corresponding decoded data (D3). Optionally, the processing hardware of the decoder is implemented by employing at least one RISC processor that is operable to execute program instructions as will be elucidated in detail below.

The processing hardware of the decoder is operable to decode the encoded data (E2) to generate intermediate data in at least a second data format. The processing hardware of the decoder is operable to determine from the encoded data (E2) one or more transformations required for transforming the intermediate data from the at least a second data format into a first data format to generate the decoded data (D3). Optionally, the aforementioned “data format” is to be regarded as being a “format space”.

Optionally, the processing hardware of the decoder is operable to transform the intermediate data from the at least a second data format, for example a color space, into a plurality of data formats, for example color spaces.

In an embodiment of the present disclosure, the processing hardware of the decoder is operable to extract, from the encoded data (E2), residual information that is indicative of one or more errors, namely distortions, arising when transforming image and/or video data (D1) from the first data format into the at least a second data format. In this embodiment, the processing hardware of the decoder is operable to apply a correction for the one or more errors, namely distortions, for enabling the encoded data (E2) to be subsequently losslessly decoded to provide the decoded data (D3).

In a third aspect, embodiments of the present disclosure provide a codec including at least one encoder and at least one decoder. The at least one encoder and the at least one decoder can be implemented as the aforementioned encoder and the aforementioned decoder, respectively.

In a fourth aspect, embodiments of the present disclosure provide a method of encoding image and/or video data (D1) to generate corresponding encoded data (E2), via an encoder including processing hardware. The image and/or video data (D1) is provided in a first data format, characterized in that the method includes:
(i) transforming the image and/or video data (D1) from the first data format into at least a second data format; and
(ii) encoding the input data in a lossless manner utilizing the at least a second data format to generate the encoded data (E2),

wherein the encoded data (E2) also includes information that is indicative of one or more transformations and/or data formats employed to transform the image and/or video data (D1) from the first data format into the at least a second data format.

According to an embodiment, the method further includes:
(i) analyzing the image and/or video data (D1); and
(ii) selecting the one or more transformations depending upon content of the image and/or video data (D1).

According to an embodiment, the method further includes transforming the image and/or video data (D1) from the first data format, for example a color space into a plurality of data formats, for example color spaces. Optionally, the aforementioned “data format” is to be regarded as being a “format space”.

According to an embodiment, (the) encoding the transformed data from the at least a second data format is more efficient than encoding the image and/or video data (D1) from the first data format directly.

According to an embodiment, the method further includes:
(i) generating residual information that is indicative of one or more errors, namely distortions, arising when transforming the image and/or video data (D1) from the first data format into the at least a second data format in a lossy manner; and
(ii) encoding the residual information into the encoded data (E2) for enabling the encoded data (E2) to be subsequently losslessly decoded.

In a fifth aspect, embodiments of the present disclosure provide a computer program product comprising a non-transitory computer-readable data storage medium having computer-readable instructions stored thereon, the computer-readable instructions being executable by a computerized device comprising processing hardware to execute the aforementioned method of encoding.

In a sixth aspect, embodiments of the present disclosure provide a method of decoding encoded data (E2) to generate corresponding decoded data (D3), via a decoder including processing hardware, characterized in that the method includes:
(i) decoding the encoded data (E2) to generate intermediate data in at least a second data format; and
(ii) determining from the encoded data (E2) one or more transformations and/or data formats required for transforming the intermediate data from the at least a second data format into a first data format to generate the decoded data (D3).

According to an embodiment, the method further includes transforming the intermediate data from the at least a second data format, for example a color space, into a plurality of data formats, for example color spaces.

According to an embodiment, the method further includes:
(i) extracting, from the encoded data (E2), residual information that is indicative of one or more errors, namely distortions, arising when transforming image and/or video data (D1) from the first data format into the at least a second data format in a lossy manner; and
(ii) applying a correction for the one or more errors, namely distortions, for enabling the encoded data (E2) to be subsequently losslessly decoded to provide the decoded data (D3).

In a seventh aspect, embodiments of the present disclosure provide a computer program product comprising a non-transitory computer-readable data storage medium having computer-readable instructions stored thereon, the computer-readable instructions being executable by a computerized device comprising processing hardware to execute the aforementioned method of decoding.

There will now be described below four solutions that at least partially overcome at least some of the problems of the prior art, as discussed earlier, namely:
(1) a first solution, wherein image and/or video data (D1) of a given image and/or video is encoded with a native compression support for multiple color spaces, to generate encoded data (E2);
(2) a second solution, wherein the image and/or video data (D1) is transformed losslessly from a given color space to a more efficient color space with substantially similar or smaller dynamics, and then encoded into the encoded data (E2);
(3) a third solution, wherein the image and/or video data (D1) is transformed losslessly from a given color space to a most efficient color space with higher dynamics, and then encoded into the encoded data (E2); and
(4) a fourth solution, wherein the image and/or video data (D1) is transformed in a lossy manner from a given color space to the most efficient color space, generating residual information that is indicative of one or more errors arising when transforming the image and/or video data (D1) from a given color space to the most efficient color space, both then encoded into the encoded data (E2), and wherein residual information is encoded additionally for enabling the encoded data (E2) to be subsequently losslessly decoded.

It will be appreciated that aforementioned examples of indexing the methods are beneficially employed. Optionally, either the index, or the selected method in some other form, is delivered, for example in the encoded data (D2) provided from the encoder to the decoder to enable lossless decoding of data. There might also be tables or transformation parameters delivered from the encoder to the decoder within the encoded data (D2) or header data, to enable appropriate inverse operation in the decoder.

It will be appreciated that information about the one or more used transformations and/or data formats can be expressed and delivered to the decoder, for the decoder to use, for example, in one or more of the following ways:
(a) information about a conversion employed in the encoder is delivered, for example in a form “RGB888 to Y'UV444”;
(b) information about an inverse conversion needed in the decoder is delivered, for example in a form “from Y'UV444 to RGB888”;
(c) information about the coefficients used in the one or more transformations and first or second data format(s) are delivered; and
(d) information about the first data format, for example RGB888, and about the second data format, for example Y'UV444, is delivered, in which case the transformation is the known transformation between those two data formats

To further elaborate an option (c) regarding coefficients, examples on matrices capable of being applied can be found at https://en.wikipedia.org/wikiiYUV. The embodiments pursuant to the disclosure optionally advantageously use the following nine 16-bit coefficients, starting with an initial constant value, with rounding:

// Calculate rounded RGB to YUV conversion
Y := (1 shl 15) + 19595 * R + 38470 * G + 7471 * B;
U := 8421376 − 11058 * R − 21710 * G + 32768 * B;
V := 8421376 + 32768 * R − 27439 * G − 5329 * B;

Which then yields the following values that fit into the correct range
between 0 and 255:

// Set clipped color values
if (Y < 0) then Y := 0
else if (Y > ((255 shl 16) − 1)) then Y := 255
else Y := Y shr 16;
if (U < 0) then U := 0
else if (U > ((255 shl 16) − 1)) then U := 255
else if (U < (128 shl 16)) then U := (U − 1) shr 16
else U := U shr 16;
if (V < 0) then V := 0
else if (V > ((255 shl 16) − 1)) then V := 255
else if (V < (128 shl 16)) then V := (V − 1) shr 16
else V := V shr 16;
).

Regarding option (c), wherein either the first data format or the second data format is delivered, advantageously it is delivered as the first data format since there is typically only one of them, and it specifies in which data format the data is lossless. The second format expresses then in which data format the data has been encoded, and there could be several of second data formats. By delivering either of them, when they are not apparent in the selected option of delivering the one or more transformations, the other data format can be properly determined, for example for purposes of transcoding directly using the data format in question. In case of several different transformations being employed, the decoder also needs to know the order in which such transformations are to be applied to the data blocks, in order to implement appropriate inverse transformations for the respective data blocks.

Furthermore, numerical values can be issued to both the data formats as well as to the transformations, to make their delivery easier. For example, a transformation from RGB888 to Y'UV444 can have a number “1”, and/or a numerical value for RGB888 format can also be, for example, “1”. With regard to transformations and to the combinations of transformations and data formats, there can be designated numerical values for encoding purposes, for example RGB=1, YUV=2, . . . and/or DC=1, Slide=2, DCT=3, . . . and/or DC_RGB=1, DC_YUV=2, . . . The same values can be issued to different things, because there is employed a delivery mechanism that provides information that is indicative whether or not a format or a transformation is delivered (from the encoder)/received (at the decoder).

The earlier aforementioned solutions (1) to (4) are operable to recognize a type of image and/or video content of the image and/or video data (D1), and to create their own file formats. Such file formats are created in a manner that enables easy modification, addition or subtraction of information in various channels, for example, during the transformation and/or the encoding.

Firstly, in respect of embodiments of the present disclosure, the native compression support for multiple color spaces will next be described.

In an embodiment of the present disclosure, image and/or video data (D1) of a given image and/or video is encoded with a native compression support for multiple color spaces and/or multiple pixel formats. Such encoding requires an efficient implementation for many different color spaces and/or for many different pixel formats, in a given codec.

In this regard, one or more color space/pixel format specific parameters are required to be used differently, or with different values, for the different color spaces and/or the different pixel formats. Optionally, the color space/pixel format specific parameters include information indicative of at least one of:
(i) an original color space of the image and/or video data (D1);
(ii) an original pixel format of the image and/or video data (D1);
(iii) a color space to be used in encoding;
(iv) a pixel format to be used in encoding;
(v) a number of channels of the image and/or video data (D1) to be encoded;
(vi) an original order of channels in the image and/or video data (D1); and/or
(vii) an order of channels to be used in encoding.

Optionally, the pixel format to be used in encoding is similar to the original pixel format, when the native compression support for the original color space and/or pixel format is used.

Optionally, the order of channels to be used in encoding is predetermined in the given codec. In an example of the YUV or YCbCr color spaces, the Y channel includes most information, and therefore, is encoded first. Similarly, in an example of the sRGB color space, the G channel includes most information, and therefore, is encoded first. This potentially enables most efficient channel correlation reduction.

Moreover, initial pixel values are also potentially different for different color spaces. As an example, a black image in the sRGB color space has a value of ‘0’ (zero) for each channel, namely each pixel is expressed with byte values of ‘0, 0, 0’ for the R, G and B channels, while in the YUV color space, a black image has a value of ‘0’ (zero) for the Y channel, and values of ‘128’ for the U and V channels, namely each pixel is expressed with byte values of ‘0, 128, 128’ for the Y, U and V channels, respectively.

Moreover, different pixel formats are potentially used within a given color space.

For example, pixel formats that are typically used for the YUV color space are I444 (24 bits per pixel), I422 (16 bits per pixel) and I420 (12 bits per pixel). A difference between these pixel formats pertains to a sampling of associated channels. When a lossless image and/or video compression is executed, the encoding is performed in a pixel format that is similar to the original pixel format of the image and/or video data (D1).

Beneficially, the processing hardware of the encoder is operable to determine the original color space and the original pixel format of the image and/or video data (D1), and to initialize the color space/pixel format specific parameters based on the determined original color space and the determined original pixel format; “initialize” is to provide initial values for the specific parameters. As a result, the processing hardware of the encoder is operable to encode losslessly the image and/or video data (D1) to generate corresponding encoded data (E2) in an optimal color space and pixel format.

Furthermore, the encoder is operable to communicate, to the decoder, at least some of the color space/pixel format specific parameters, for example, including information indicative of the color space and the pixel format used in the encoding. The at least some of the color space/pixel format specific parameters can be communicated in a form of a saved file or a data stream, for example, typically implemented via a use of a header.

Upon receiving the at least some of the color space/pixel format specific parameters, the decoder is operable to initialize the color space/pixel format specific parameters, and to decode the encoded data (E2) to generate corresponding decoded data (D3). The decoded data (D3) can be generated either in the original color space and/or the original pixel format or in any other color space and/or pixel format, as desired. Optionally, the decoder can initialize all needed parameters based on information delivered to it and received by it.

Secondly, lossless transformation from a given color space to a more efficient color space will next be described in relation to embodiments of the present disclosure.

In an embodiment of the present disclosure, the processing hardware of the encoder is operable to transform losslessly image and/or video data (D1) of a given image and/or video from an original color space to a more efficient color space with substantially similar or smaller dynamics. Thus, the encoding is performed in the more efficient color space and a pixel format associated therewith.

Throughout the present disclosure, the term “dynamics” generally refers to a number of bits per pixel with which a channel is expressed. For example, in the I444 pixel format for the YUV color space, there are 24 bits per pixel, namely 8 bits per pixel for each of the Y, U and V channels. For example, in the I420 pixel format for the YUV color space there are in average 12 bits per pixel namely 8 bits per pixel for the Y channel and 8 bits per every four pixel group of for each of the U and V channels. Similarly, in the RGB16 pixel format has 6 bits per pixel for the G channel and 5 bits for pixel each of the B and R channels. Generally, the “dynamics”, namely dynamic range, means a value range of any given value, namely a difference between a largest value in the value range and a smallest value in the value range, and a precision of expressing the given value. The dynamics are optionally obtained by, for example, measuring, by executing an A/D conversion, or by otherwise selecting and converting a value range. The more the values vary, or the more precise a variance is expressed, the more bits, namely “dynamics”, are needed for expressing the given value, whether the given value indicates color pixels, audio amplitude or any other value that has been obtained by measuring or by converting. The embodiments pursuant to the present disclosure are concerned, for example, with discrete values, and AD/DA conversions can be executed before or after the system. However, it is rarely possible to guarantee losslessness unless analogical signals are used to express, for example, bit values.

It will be appreciated that there are only a few cases in which it is possible to transform an image and/or video from a first color space to a second color space in the encoder and to reverse the transformation in the decoder losslessly, without increasing used dynamics from the first color space to the second color space. As an example, monochrome (namely, greyscale) images are often transformable from one color space to another color space with substantially similar dynamics, whereas color images typically cannot be transformed losslessly without increasing the used dynamics.

In a typical example, a transformation from the sRGB color space to the YUV color space, and back from the YUV color space to the sRGB color space, or vice versa is not lossless for most color images and/or videos. Therefore, it is beneficial to define proprietary transformations that are substantially lossless for certain types of image and/or video content.

In another example, when original image and/or video content of the image and/or video data (D1) does not include full dynamics or the transformation reduces the dynamics, it is possible to use smaller dynamics during the encoding.

Moreover, optionally, the encoder is operable to communicate, to the decoder, information about original dynamics and dynamics used during the encoding.

Moreover, optionally, during the encoding, the processing hardware of the encoder is operable to reuse certain parts from a codec implementation that was originally designed for the first color space and/or the associated pixel format.

Optionally, the encoder employs a pre-color-converter for the lossless transformation. Optionally, the encoder also delivers the pre-color-converter to the decoder, so as to enable support for the second color space during encoding operations and subsequent decoding operations. The pre-color-converter is optionally employed by way of using a natural color space and/or pixel format of the given codec.

It will be appreciated that it is beneficial for the given codec to support multiple native color spaces, both during the encoding operations and during the decoding operations. This enables the encoder to select a more efficient color space, from the multiple native color spaces supported by the given codec, for encoding purposes. Such a selection is beneficially made quite efficiently and accurately, without a need to execute full encoding with different color spaces. Optionally, in this regard, the selection of the more efficient color space is beneficially made by using a color space that gives a smaller entropy sum of data in channels for the entire image and/or video content of the image and/or video data (D1). Entropy, for selection purposes, is beneficially computed using Shannon's Theorem. Optionally, the selection is made directly based on a comparison of encoding results with different formats, even if the use of entropy computations makes the selection quicker and often produces a similar end result; in other words, an achieved quality of encoding is not a selection criteria here, but either the amount of used bits or the amount estimated by using the entropy.

Thirdly, lossless transformation from a given color space to a most efficient color space will next be described, for embodiments of the present disclosure.

In an embodiment of the present disclosure, the processing hardware of the encoder is operable to transform losslessly image and/or video data (D1) of a given image and/or video from an original color space to a most efficient color space with higher dynamics. Thus, the encoding is performed in the most efficient color space and a pixel format associated therewith.

As the given image and/or video is encoded with higher dynamics, it is possible to transform from the original color space to the most efficient color space in the encoder and to reverse the transformation in the decoder losslessly.

Moreover, optionally, the encoder is operable to communicate, to the decoder, information about original dynamics and dynamics used during the encoding. Fourthly, lossy transformation from a given color space to a most efficient color space in embodiments of the present disclosure will next be described.

In an embodiment of the present disclosure, the processing hardware of the encoder is operable to transform image and/or video data (D1) of a given image and/or video from an original color space to a most efficient color space in a lossy manner. Additionally, in this embodiment, the processing hardware of the encoder is operable to generate and encode residual information and to deliver the encoded residual information to the decoder, so as to enable a lossless implementation to be achieved.

The fourth solution is particularly beneficial when the native compression support for the original color space is not available or is not efficient enough. In such a case, the solution improves an associated compression ratio considerably, as compared to a compression ratio associated with the native compression support.

The encoding of the transformed data is performed in the most efficient color space and a pixel format associated therewith. Optionally, the residual information is entropy encoded with a most advanced entropy-modifying encoder.

As described earlier, the residual information is indicative of one or more errors, namely distortions, arising when transforming the image and/or video data (D1) from the original color space into the most efficient color space. Thus, the residual information enables lossless image and/or video compression, even when the transformation from the original color space to the most efficient color space and the reverse of the transformation are not lossless.

The errors arising from the transformation typically include values of ‘0’, ‘−1’ and ‘+1’ in a structured manner. Therefore, it is advantageous to encode the residual information by using, for example, a modified ODelta operator, as described in the patent document GB 1412937.3. In some examples, the residual information is encoded by using Run Length Encoding (RLE) or Split RLE (SRLE), the latter being described in the patent document GB 2507603.

It will be appreciated that when different sampling is used for generating, for example via executing computations within a data processing arrangement, different channels in a given color image and/or video, for example, as in the I422 or I420 pixel formats for the YUV color space (or Bayer sampling for B, G, and R pixel values), the color image and/or video is typically encoded in a native format using the native compression support, namely the aforementioned first solution. Otherwise, optionally, up-sampling (or de-mosaicing) is performed in the encoder before the transformation and down-sampling (mosaicing) is performed in the decoder after the transformation back to the original pixel format. Sampling is known in the art, and is described in databases such as Wikipedia.

As an example of other than image and/or video data, an embodiment of the present disclosure is provided, wherein audio data is quantized starting from 48 kHz 16-bit samples to generate 16 kHz 8-bit samples, for example for purposes of coding speech data. Correspondingly, this is then recovered back into the original sampling rate and dynamics after coding and residual coding.

Sometimes, an amount of data in up-sampled channels is increased so much that it is potentially not efficient to compress, as compared to the native compression support that can compress images in a sub-sampled format. In such a case, the aforementioned fourth method is optionally used. When the fourth method is used, it is potentially advantageous to subsample at least some channels in another color space, namely the most efficient color space, before the encoding. Later, in the decoder, a corresponding up-sampling is performed before reversing the transformation to the original color space. Thereafter, a down-sampling is performed to return the image and/or video back to the original pixel format, including sampling.

Next, embodiments of the present disclosure will be described with reference to figures.

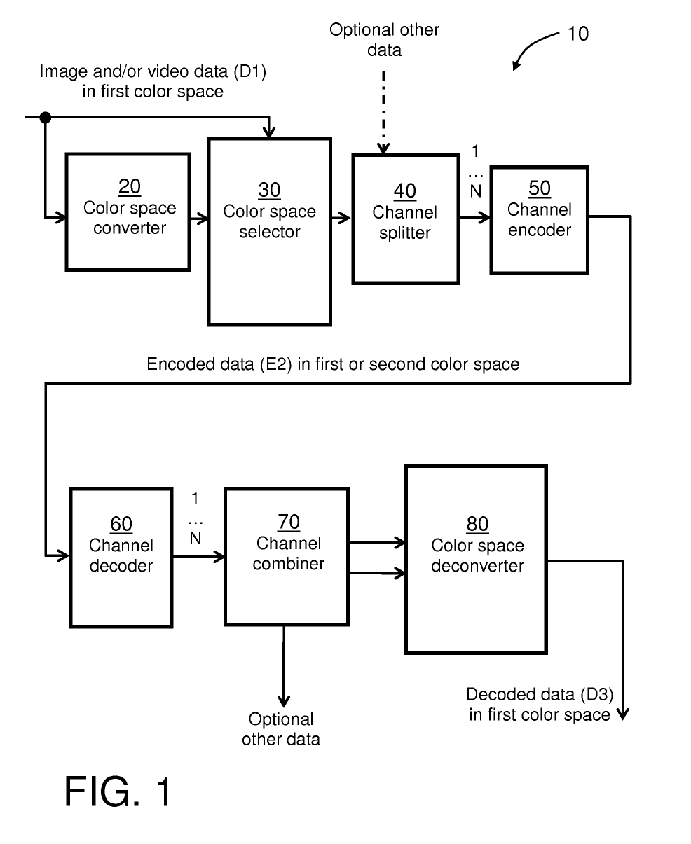

Referring to FIG. 1, there is shown a block diagram of a codec 10, pursuant to embodiments of the present disclosure. The codec 10 includes a color space converter 20, a color space selector 30, a channel splitter 40, a channel encoder 50, a channel decoder 60, a channel combiner 70, and optionally, a color space deconverter 80. The color space converter 20, the color space selector 30, the channel splitter 40 and the channel encoder 50 form a part of an encoder of the codec 10, while the channel decoder 60, the channel combiner 70 and the color space deconverter 80 form a part of a decoder of the codec 10.

The color space converter 20 is operable to transform image and/or video data (D1) from a first color space to at least a second color space. The color space selector 30 is operable to select an efficient color space to be used for the transformation, namely the at least a second color space.

Optionally, the color space selector 30 is operable to generate residual information corresponding to the transformation.

The channel splitter 40 is operable to split the transformed data into a plurality of channels, represented by ‘1 . . . N’ in FIG. 1. The channel splitter 40 is optionally implemented by way of a demultiplexer. Multiplexing and demultiplexing techniques are described in greater detail at:

http://en.wikipedia.org/wiki/Multiplexer

Optionally, the channel splitter 40 is also fed with other data, for example, such as metadata and other critical data.

The channel encoder 50 is operable to encode the transformed data to generate corresponding encoded data (E2).

Optionally, the channel encoder 50 is operable to encode channels of the transformed data one-by-one. Optionally, in this regard, the channel encoder 50 is operable to encode more-relevant channels before encoding less-relevant channels.

In an embodiment, the channel encoder 50 is operable to encode the residual information into the encoded data (E2).

In the decoder, the channel decoder 60 is operable to decode the encoded data (E2) to generate the aforesaid channels of the transformed data.

The channel combiner 70 is then operable to combine the channels together to produce the aforesaid transformed data. The channel combiner 70 is optionally implemented by way of a multiplexer.

The color space deconverter 80 is operable to reverse the one or more transformations to generate corresponding decoded data (D3).

In an embodiment, the color space deconverter 80 is operable to decode the residual information to enable lossless retrieval of the decoded data (D3).

Additionally, optionally, the codec 10 includes a header extractor (not shown in FIG. 1). The header extractor is employed to extract an original header of the image and/or video data (D1). The header extractor is typically employed before the color space converter 20 and the color space selector 30 of the encoder. Additionally, optionally, the codec 10 includes an output image and/or video formatter (not shown in FIG. 1). The output image and/or video formatter is employed, when it is desired to store the decoded data (D3) to an image and/or video file, or the usage of the decoded data (D3) requires a specific file format.

The output image and/or video formatter is typically employed after the color space deconverter 80 of the decoder.

It will be appreciated that FIG. 1 is a high level abstraction of the codec 10. Components related to data transmission between the encoder and the decoder, for example, such as a file formatter, a stream formatter and similar, are not shown in FIG. 1. Moreover, other components of the encoder and the decoder, for example, such as analysis units, temporal and spatial redundancy reduction units, entropy encoders and corresponding entropy decoders, a bit stream generation unit and a corresponding bit stream degeneration unit, are also not shown in FIG. 1. Furthermore, sub-sampling and up-sampling features are also not shown in FIG. 1.

FIG. 1 is merely an example, which should not unduly limit the scope of the claims herein. It is to be understood that the specific designation for the codec is provided as an example and is not to be construed as limiting the codec to specific numbers, types, or arrangements of its components. A person skilled in the art will recognize many variations, alternatives, and modifications of embodiments of the present disclosure.

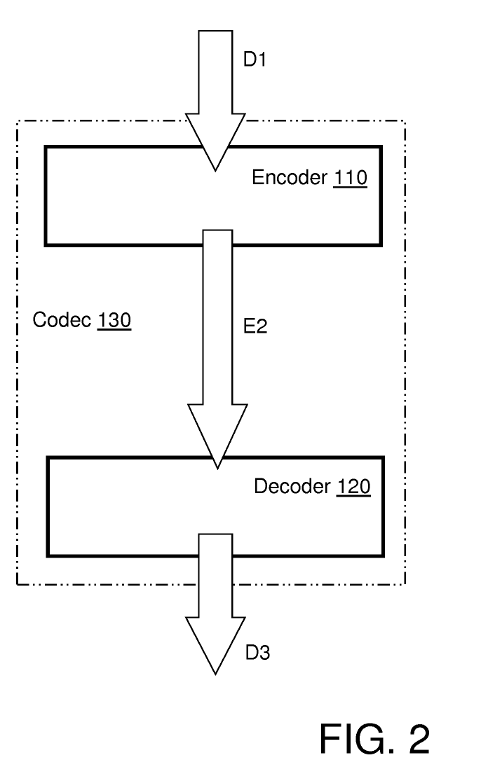

Referring next to FIG. 2, embodiments of the present disclosure concern:
(i) an encoder 110 for encoding image and/or video data (D1) to generate corresponding encoded data (E2), and corresponding methods of encoding the image and/or video data (D1) to generate the corresponding encoded data (E2);
(ii) a decoder 120 for decoding the encoded data (E2) to generate corresponding decoded data (D3), and corresponding methods of decoding the encoded data (E2) to generate the decoded data (D3); and
(iii) a codec 130 including a combination of at least one encoder and at least one decoder, namely a combination of the encoder 110 and the decoder 120.

Optionally, the decoded data (D3) is exactly similar to the image and/or video data (D1), as in a lossless mode of operation. Alternatively, optionally, the decoded data (D3) is approximately similar to the image and/or video data (D1), as in a lossy mode of operation. Yet alternatively, optionally, the decoded data (D3) is different to the image and/or video data (D1), for example by way of at least one transformation, but retains substantially similar information present in the image and/or video data (D1); for example, the decoded data (D3) is usefully made different to the image and/or video data (D1) when reformatting of the decoded data (D3) is also required, for example to be compatible with different types of communication platforms, software layers, communication devices, and so forth. Optionally, the data can be reconstructed in the decoder in some desired data format, other than the first data format, namely in a destination data format. Transcoding of the data into such a destination data format can be executed directly from the second data format or not until from the first data format. It is usually more efficient to transcode the data directly from the second data format, but in some cases, for the purposes of the accuracy of the data or due to coding being executed only once, or only one transformation being used, the transcoding is not done until from the first data format, to which format the encoding data format is decoded to.

FIG. 2 is merely an example, which should not unduly limit the scope of the claims herein. It is to be understood that the specific designation for the codec 130 is provided as an example and is not to be construed as limiting the codec 130 to specific numbers, types, or arrangements of encoders and decoders. A person skilled in the art will recognize many variations, alternatives, and modifications of embodiments of the present disclosure

Optionally, the codec 130 is implemented within a single device. Alternatively, optionally, the codec 130 is effectively implemented between multiple devices. Optionally, the codec 130 is implemented as custom-design digital hardware, for example, via use of one or more Application-Specific Integrated Circuits (ASIC's). Alternatively, or additionally, the codec is implemented in computer software instructions executable upon processing hardware.

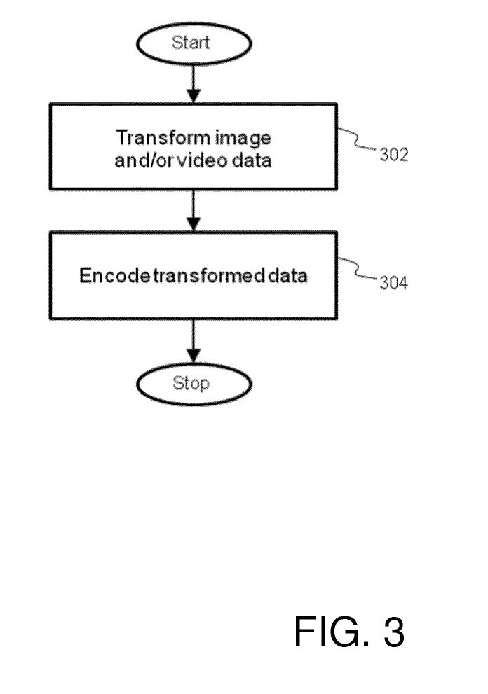

Referring now to FIG. 3, there is provided a flow chart depicting steps of a method of encoding image and/or video data (D1) to generate corresponding encoded data (E2), in accordance with an embodiment of the present disclosure. The method is depicted as a collection of steps in a logical flow diagram, which represents a sequence of steps that can be implemented in hardware, software, or a combination thereof, for example as aforementioned.

The method is implemented via an encoder including processing hardware. The image and/or video data (D1) is provided in a first data format.

At a step 302, the image and/or video data (D1) is transformed from the first data format into at least a second data format.

At a step 304, the transformed data from the at least a second data format is encoded to generate the encoded data (E2).

The steps 302 to 304 are only illustrative and other alternatives can also be provided where one or more steps are added, one or more steps are removed, or one or more steps are provided in a different sequence without departing from the scope of the claims herein. In an embodiment, the method includes an additional step at which residual information is generated and encoded, for enabling the encoded data (E2) to be subsequently losslessly decoded.

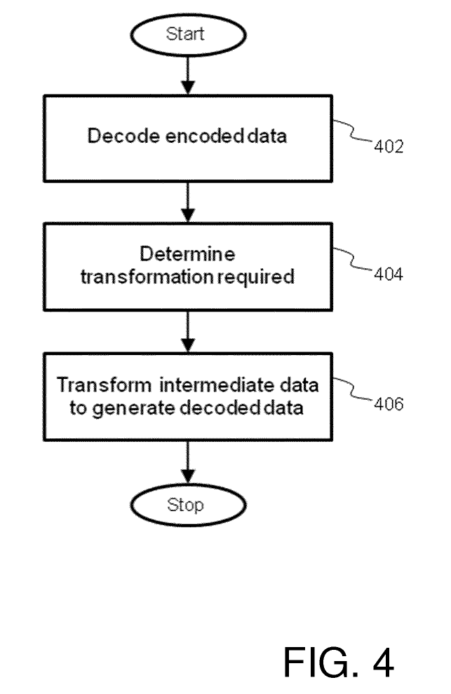

Referring now to FIG. 4, there is provided a flow chart depicting steps of a method of decoding encoded data (E2) to generate corresponding decoded data (D3), in accordance with an embodiment of the present disclosure. The method is depicted as a collection of steps in a logical flow diagram, which represents a sequence of steps that can be implemented in hardware, software, or a combination thereof, for example as aforementioned.

The method is implemented via a decoder including processing hardware.

At a step 402, the encoded data (E2) is decoded to generate intermediate data in at least a second data format.

At a step 404, one or more transformations required for transforming the intermediate data from the at least a second data format into a first data format is determined from the encoded data (E2). At a step 406, the intermediate data is transformed to generate the decoded data (D3).

The steps 402 to 406 are only illustrative and other alternatives are also optionally provided where one or more steps are added, one or more steps are removed, or one or more steps are provided in a different sequence without departing from the scope of the claims herein. In an embodiment, the method includes one or more additional steps at which residual information is extracted from the encoded data (E2), and a corresponding correction is applied for enabling the encoded data (E2) to be subsequently losslessly decoded to provide the decoded data (D3).

Modifications to embodiments of the present disclosure described in the foregoing are possible without departing from the scope of the present disclosure as defined by the accompanying claims. Expressions such as “including”, “comprising”, “incorporating”, “consisting of”, “have”, “is” used to describe and claim embodiments of the present disclosure are intended to be construed in a non-exclusive manner, namely allowing for items, components or elements not explicitly described also to be present. Reference to the singular is also to be construed to relate to the plural. Numerals included within parentheses in the accompanying claims are intended to assist understanding of the claims and should not be construed in any way to limit subject matter claimed by these claims.

### REFERENCES

[1] YUV-Wikipedia, the free encyclopedia (accessed Sep. 30, 2014). URL: http://en.wikipedia.org/wiki/YUV

1. An encoder including processing hardware for encoding input data in a lossless manner to generate corresponding encoded data, wherein the input data is provided in a first data format, characterized in that:
the processing hardware of the encoder is operable to transform the input data from the first data format into at least one second data format,
and to encode the input data utilizing the at least one second data format to generate the encoded data, utilizing at least one of:
(i) a lossless transformation:
the data is transformed losslessly from the first data format having a first dynamics into the at least one second data format having a second dynamics, wherein the second dynamics is similar or smaller than the first dynamics, and then encoded into the encoded data;
the data is transformed losslessly from the first data format having a first dynamics into the at least one second data format having a second dynamics, wherein the second dynamics have higher dynamics than the first dynamics, thereby enlarging original dynamics of the data, and then encoded into the encoded data; and
(ii) a lossy transformation:
the processing hardware is operable to generate residual information that is indicative of one or more distortions arising when transforming the input data from the first data format into the at least a second data format in a lossy manner, and the processing hardware of the encoder is operable to encode the residual information into the encoded data for enabling the encoded data to be subsequently losslessly decoded;
the processing hardware is operable to combine different distortions arising from employing lossy transformations and/or lossy coding, when transforming the input data from the second format to generate the encoded data, and to include information indicative of the combined different distortions in the encoded data so that lossless encoding is thereby provided;
wherein the encoded data includes information that is indicative of a one or more transformations and/or data formats employed to transform the input data from the first data format into the at least one second data format.

2. An encoder as claimed in claim 1, characterized in that the encoder (110) is operable to generate the encoded data including information indicative of the one or more transformations and/or the data formats employed to transform the input data from the first data format into the at least one second data format, wherein the information contains at least one of:
(a) information indicative of a conversion employed in the encoder, for example in a form “first data format to second data format”;
(b) information indicative of an inverse conversion needed in a decoder, for example in a form “from a second data format to a first data format”;
(c) information indicative of coefficients used in the one or more transformations and either the first or the second data format; and
(d) information indicative of the first data format and the second data format.

3. An encoder as claimed in claim 1, characterized in that the input data includes image and/or video data, the first data format includes a first color space, and the second data format includes a second color space.

4. An encoder as claimed in any one of claim 1, characterized in that the processing hardware of the encoder is operable to analyze the input data, and to select the one or more transformations depending upon content of the input data.

5. An encoder as claimed in claim 4, characterized in that the processing hardware of the encoder is operable to transform the input data from the first data format into a plurality of data formats.

6. An encoder as claimed in claim 5, characterized in that the processing hardware of the encoder is operable to transform the input data including image and/or video data from a first data format into a plurality of data formats.

7. An encoder as claimed in claim 1, characterized in that the encoding of the transformed data from the at least a second data format is more efficient than encoding the input data from the first data format directly.

8. (canceled)

9. (canceled)

10. A method of encoding input data in a lossless manner to generate corresponding encoded data, via an encoder including processing hardware, wherein the input data is provided in a first data format, characterized in that the method includes:
utilizing at least one of:
for a lossless transformation:
transforming the data losslessly from the first data format having a first dynamics into the at least one second data format having a second dynamics, wherein the second dynamics is similar or greater than the first dynamics, and then encoding into the encoded data;
transforming the data losslessly from the first data format having a first dynamics into the at least one second data format having a second dynamics, wherein the second dynamics have higher dynamics than the first dynamics, thereby enlarging original dynamics of the data, and then encoding into the encoded data; and
for a lossy transformation:
operating the processing hardware to generate residual information that is indicative of one or more distortions arising when transforming the input data from the first data format into the at least a second data format in a lossy manner, and operating the processing hardware of the encoder to encode the residual information into the encoded data for enabling the encoded data to be subsequently losslessly decoded; and
operating the processing hardware to combine different distortions arising from employing lossy transformations and/or lossy coding, when transforming the input data from the second format to generate the encoded data, and including information indicative of the combined different distortions in the encoded data so that lossless encoding is thereby provided;
wherein the encoded data also includes information that is indicative of one or more transformations and data formats employed to transform the input data from the first data format into the at least a second data format.

11. A method as claimed in claim 10, characterized in that the method includes generating the encoded data including information indicative of the one or more transformations and/or the data formats employed to transform the input data from the first data format into the at least one second data format, wherein the information contains at least one of:
(a) information indicative of a conversion employed in the encoder, for example in a form “first data format to second data format”;
(b) information indicative of an inverse conversion needed in a decoder, for example in a form “from a second data format to a first data format”;
(c) information indicative of coefficients used in the one or more transformations and either the first or the second data format; and
(d) information indicative of the first data format and the second data format.

12. A method as claimed in claim 10, characterized in that the input data includes image and/or video image data, the first data format includes a first color space, and the second data format includes a second color space.

13. A method as claimed in claim 10, characterized in that the method includes:
(i) analyzing the input data; and
(ii) selecting the one or more transformations depending upon content of the input data.

14. A method as claimed in claim 10, characterized in that the method includes transforming the input data from the first data format into a plurality of data formats.

15. A method as claimed in claim 13, characterized in that the method includes transforming the input data from a first data format into a plurality of data formats.

16. (canceled)

17. (canceled)

18. A decoder including processing hardware for decoding encoded data in a lossless manner to generate corresponding decoded data, characterized in that the processing hardware of the decoder is operable to decode the encoded data to generate intermediate data in at least a second data format, and to determine from the encoded data one or more transformations and data formats required for transforming the intermediate data from the at least a second data format into a first data format to generate the decoded data.

19. A decoder as claimed in claim 18, characterized in that the processing hardware of the decoder is operable to determine from the encoded data information indicative of the one or more transformations and/or the data formats employed to transform the input data from the first data format into the at least one second data format, such information containing at least one of:
(a) information indicative of a conversion employed in an encoder, for example in a form “first data format to second data format”;
(b) information indicative of an inverse conversion needed in the decoder, for example in a form “from second data format to first data format”;
(c) information indicative of coefficients used in the one or more transformations and either the first or the second data format; and
(d) information indicative of the first data format and the second data format.

20. A decoder as claimed in claim 18, characterized in that the decoded data includes image and/or video data, the first data format includes a first color space, and the second data format includes a second color space.

21. A decoder as claimed in claim 18, characterized in that the processing hardware of the decoder is operable to transform the intermediate data from the at least a second data format into a plurality of data formats.

22. A decoder as claimed in claim 18, characterized in that the processing hardware of the decoder is operable to extract, from the encoded data, residual information that is indicative of one or more distortions arising when transforming input data from the first data format into the at least a second data format in a lossy manner, and the processing hardware of the decoder is operable to apply a correction for the one or more distortions for enabling the encoded data to be subsequently losslessly decoded to provide the decoded data.

23. A method of decoding encoded data to generate corresponding decoded data, via a decoder including processing hardware, characterized in that the method includes:
(i) decoding the encoded data in a lossless manner to generate intermediate data in at least a second data format; and
(ii) determining from the encoded data one or more transformations and data formats required for transforming the intermediate data from the at least a second data format into a first data format to generate the decoded data.

24. A method as claimed in claim 23, characterized in that the decoder is operable to process the encoded data including information indicative of the one or more transformations and/or the data formats employed to transform the input data from the first data format into the at least one second data format, wherein the information contains at least one of:
(a) information indicative of a conversion employed in an encoder, for example in a form “first data format to second data format”;
(b) information indicative of an inverse conversion needed in the decoder, for example in a form “from second data format to first data format”;
(c) information indicative of coefficients used in the one or more transformations and either the first or the second data format; and
(d) information indicative of the first data format and the second data format.

25. A method as claimed in claim 23, characterized in that the method includes transforming the intermediate data from the at least a second data format into a plurality of data formats.

26. A method as claimed in claim 23, characterized in that the method includes:
(i) extracting, from the encoded data, residual information that is indicative of one or more distortions arising when transforming input data from the first data format into the at least a second data format in a lossy manner; and
(ii) applying a correction for the one or more distortions for enabling the encoded data to be subsequently losslessly decoded to provide the decoded data.

27. A codec including at least one encoder comprising:
processing hardware of the encoder operable to transform input data from a first data format into at least one second data format,
and operable to encode the input data utilizing the at least one second data format to generate the encoded data, utilizing at least one of:
(i) a lossless transformation:
the data is transformed losslessly from the first data format having a first dynamics into the at least one second data format having a second dynamics, wherein the second dynamics is similar or smaller than the first dynamics, and then encoded into the encoded data,
the data is transformed losslessly from the first data format having a first dynamics into the at least one second data format having a second dynamics, wherein the second dynamics have higher dynamics than the first dynamics, thereby enlarging original dynamics of the data, and then encoded into the encoded data, and
(ii) a lossy transformation:
the processing hardware is operable to generate residual information that is indicative of one or more distortions arising when transforming the input data from the first data format into the at least a second data format in a lossy manner, and the processing hardware of the encoder is operable to encode the residual information into the encoded data for enabling the encoded data to be subsequently losslessly decoded;
the processing hardware is operable to combine different distortions arising from employing lossy transformations and/or lossy coding, when transforming the input data from the second format to generate the encoded data, and to include information indicative of the combined different distortions in the encoded data so that lossless encoding is thereby provided;
wherein the encoded data includes information that is indicative of a one or more transformations and/or data formats employed to transform the input data from the first data format into the at least one second data format.

28. A computer program product comprising a non-transitory computer-readable storage medium having computer-readable instructions stored thereon, the computer-readable instructions being executable by a computerized device comprising processing hardware to execute a method comprising:
utilizing at least one of:
for a lossless transformation:
transforming the data losslessly from the first data format having a first dynamics into the at least one second data format having a second dynamics, wherein the second dynamics is similar or greater than the first dynamics, and then encoding into the encoded data;
transforming the data losslessly from the first data format having a first dynamics into the at least one second data format having a second dynamics, wherein the second dynamics have higher dynamics than the first dynamics, thereby enlarging original dynamics of the data, and then encoding into the encoded data; and
for a lossy transformation:
operating the processing hardware to generate residual information that is indicative of one or more distortions arising when transforming the input data from the first data format into the at least a second data format in a lossy manner, and operating the processing hardware of the encoder to encode the residual information into the encoded data for enabling the encoded data to be subsequently losslessly decoded; and
operating the processing hardware to combine different distortions arising from employing lossy transformations and/or lossy coding, when transforming the input data from the second format to generate the encoded data, and including information indicative of the combined different distortions in the encoded data so that lossless encoding is thereby provided;
wherein the encoded data also includes information that is indicative of one or more transformations and data formats employed to transform the input data from the first data format into the at least a second data format.
